(19) United States
(12) Patent Application Publication
(10) Pub. No.: US 2021/0141822 A1
(43) Pub. Date: May 13, 2021

(54) SYSTEMS AND METHODS FOR IDENTIFYING LATENT THEMES IN TEXTUAL DATA

(71) Applicant: MicroStrategy Incorporated, Tysons Comer, VA (US)

(72) Inventor: Jericho McLEOD, Arlington, VA (US)

(73) Assignee: MicroStrategy Incorporated, Tysons Corner, VA (US)

(21) Appl. No.: 17/084,581

(22) Filed: Oct. 29, 2020

Related U.S. Application Data
(60) Provisional application No. 62/933,594, filed on Nov. 11, 2019.

(51) Int. Cl. G06F 16/35; G06F 16/93

(52) U.S. Cl. CPC G06F 16/353; G06F 16/93

(57) ABSTRACT

A computer-implemented method for identifying latent themes in textual data may include receiving a plurality of documents, preprocessing document text for each document among the plurality of documents, calculating a similarity of each pair of documents among the plurality of preprocessed documents, determining one or more document clusters among the plurality of preprocessed documents based on the calculated similarity of each pair of documents among the plurality of preprocessed documents and extracting one or more topics in each document cluster among the determined one or more document clusters

### CROSS-REFERENCE TO RELATED APPLICATION(S)

This application claims the benefit of priority to U.S. Provisional Patent Application No. 62/933,594, filed Nov. 11, 2019, the entirety of which is incorporated by reference herein.

### TECHNICAL FIELD

Various embodiments of the present disclosure relate generally to topic extraction in a corpus of documents and, more particularly, to identifying latent themes in textual data of the documents through clustering of documents and extracted topics.

### BACKGROUND

Many business processes may generate large numbers of documents, each of which may pertain to multiple topics. However, it may be difficult or infeasible to identify common topics or themes among the documents. The present disclosure is directed to overcoming one or more of these challenges.

### SUMMARY OF THE DISCLOSURE

According to certain aspects of the present disclosure, systems and methods are disclosed for identifying latent themes in textual data.

In one embodiment, a computer-implemented method is disclosed for identifying latent themes in textual data, the method comprising: receiving a plurality of documents, preprocessing document text for each document among the plurality of documents, calculating a similarity of each pair of documents among the plurality of preprocessed documents, determining one or more document clusters among the plurality of preprocessed documents based on the calculated similarity of each pair of documents among the plurality of preprocessed documents and extracting one or more topics in each document cluster among the determined one or more document clusters.

In accordance with another embodiment, a system is disclosed for identifying latent themes in textual data, the system comprising: a data storage device storing instructions for identifying latent themes in textual data in an electronic storage medium; and a processor configured to execute the instructions to perform a method including: receiving a plurality of documents, preprocessing document text for each document among the plurality of documents, calculating a similarity of each pair of documents among the plurality of preprocessed documents, determining one or more document clusters among the plurality of preprocessed documents based on the calculated similarity of each pair of documents among the plurality of preprocessed documents and extracting one or more topics in each document cluster among the determined one or more document clusters.

In accordance with another embodiment, a non-transitory machine-readable medium storing instructions that, when executed by the a computing system, causes the computing system to perform a method for identifying latent themes in textual data, the method including: receiving a plurality of documents, preprocessing document text for each document among the plurality of documents, calculating a similarity of each pair of documents among the plurality of preprocessed documents, determining one or more document clusters among the plurality of preprocessed documents based on the calculated similarity of each pair of documents among the plurality of preprocessed documents and extracting one or more topics in each document cluster among the determined one or more document clusters.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary process flow for a method for identifying latent themes in textual data, according to one or more embodiments.

FIGS. 2A-2C depict preprocessing a corpus of textual data in a method for identifying latent themes in textual data, according to one or more embodiments.

FIGS. 3A-3B depict determining similarity in a corpus of textual data in a method for identifying latent themes in textual data, according to one or more embodiments.

FIGS. 4A-4B depict determining clusters within a corpus of textual data in a method for identifying latent themes in textual data, according to one or more embodiments.

FIGS. 5A-5D depict extracting topics in a corpus of textual data in a method for identifying latent themes in textual data, according to one or more embodiments.

FIG. 6 depicts a flowchart of a method of identifying latent themes in textual data, according to one or more embodiments.

### DETAILED DESCRIPTION OF EMBODIMENTS

Various embodiments of the present disclosure relate generally to identifying latent themes in textual data.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

As discussed above, many business processes may generate a large number, or corpus, of documents. Each of these documents may pertain to a single major topic. However, each document may also pertain to one or more additional topics. The business process may be able to identify major topics in documents generated by that process. However, secondary topics may be more difficult to identify. Furthermore, multiple business processes may generate other collections of documents that may pertain to the same primary and secondary topics. Analysis that does not consider the documents generated from all such processes as a single corpus may not identify all of the relevant topics. Accordingly, important trends that could be identified in the corpus of documents may be missed until much later. The methods discussed below may provide for the discovery of such “latent” topics in the corpus of documents.

For example, consider a software company that receives reports of software defects from users and from in-house quality assurance (QA) processes. Such defect reports will likely be categorized by major feature, release, operating system, etc. These categorizations may be considered the “major” topics of the defect reports. However, there may be common topics with the descriptions of the defect reports that are not captured by the categorizations. These “latent” topics may suggest common areas of concern that may be subject to additional QA testing or software audits. In addition, such “latent” topics may identify tends in user interests before such interests become primary topics of user feedback. Recognizing and understanding these topics may help the company plan new features for future releases. A method for identifying these “latent” topics, thus, may provide benefits for the software company.

FIG. 1 depicts an exemplary process flow for a method 100 for identifying latent themes in textual data, according to one or more embodiments. As shown in FIG. 1, a corpus of electronic documents 110 may be provided for analysis to identify latent themes. The corpus may first be provided to a preprocessor 120, which may preprocess the documents in the corpus to put the text data in better form for further analysis. The pre-processor 120 may comprise one or more software modules, and the documents 110 may be received over an electronic network. As discussed in further detail below with respect to FIGS. 2A-2C, the preprocessing may include, for example, lemmatizing and tokenizing the text, removing stop words from the text, and generating a list, or vector, of common words within the text. Data resulting from the preprocessing may then be provided to similarity analyzer 130. As discussed below with respect to FIGS. 3A-3B, the similarity analysis may include, for example, measuring the similarity of documents within the corpus, which may be based on a count of the instances of common words in a document. Data resulting from the similarity analysis may then be provided to clustering analyzer 140. As discussed below with respect to FIGS. 4A-4B, the clustering analysis may include aggregating documents within the corpus into clusters based on the similarity analysis. Data resulting from the clustering analysis may then be provided to topic extractor 150. As discussed below with respect to FIGS. 5A-5D, the topic extraction may include, for example, extracting topics within the clusters of documents and associating documents within the clusters. Finally, data resulting from the topic extraction may be provided to a reporting module or user interface 160.

FIGS. 2A-2C depict preprocessing a corpus of textual data in a method for identifying latent themes in textual data, according to one or more embodiments. As shown in FIG. 2A, corpus of documents 110 may include one or more documents 210, each comprising textual data 220. Textual data 220 may include, for example, legible text in a human language, such as the English-language text depicted in FIG. 2A. Textual data 220 may include data in other human-readable languages or may include data that is not in a human-readable language, such as, for example, encoded data. For purposes of illustration, textual data 220 is depicted as short English-language sentences. However, textual data 220 may include data of any length. Human-readable language data may comprise, for example, sentences, paragraphs, or entire documents of any length. Likewise, non-human-readable data stored in textual data 220 may be of any length or structure. Each document 210 in corpus 110 may be preprocessed by preprocessor 120. For example, textual data 220 for each document 210 may be lemmatized in order to simplify words by grouping inflected or variant forms of the same word, stemmed in order to reduce inflected, or derived, words to their word stem, base or root form, and tokenized in order to demarcate sections of textual data 220. Textual data 220 may also be processed to remove “stop words,” which may be, for example, common short functional words such as “the,” “is,” “at,” “which,” “on,” etc., that may not provide additional substantive information in the document. The identification of “stop words” to be removed may be based, for example, on a static or dynamic list (not shown) or may be based on a grammar of the text contained in textual data 220. As shown in FIG. 2B, original document 210 has been preprocessed into document 240 comprising a list of words in the document. In document 240, the original words “airplanes” and “fly” have been lemmatized and stemmed into tokens “airplan” and “fli,” respectively. In addition “stop words” including “can,” “then,” “the,” and “of” have been removed from textual data 220 to produce preprocessed textual data 250. Following the pre-processing of textual data 220 across all documents in corpus 110, a list of common words appearing in the textual data may be compiled, as shown in FIG. 2C. For example, a list 270 of common words 280 across preprocessed documents 240 may be compiled. The list 270 of common words may include a subset of words appearing in preprocessed textual data 250 across all preprocessed documents 240 or may include all such words. For example, list 270 of common words may include words appearing a threshold number of times in preprocessed textual data 250 across all preprocessed documents 240 or may be selected based on other criteria.

Preprocessing of the textual data contained in corpus 110, as shown in FIGS. 2A-2C, may ensure that differing forms of words contained in each document are mapped to a common form so as to allow better detection of similarities between the documents and the extraction of topics contained within them.

FIGS. 3A-3B depict determining similarity in a corpus of textual data in a method for identifying latent themes in textual data, according to one or more embodiments. As shown in FIG. 3A, determining a similarity between documents 210 in corpus 110 may include counting the instances of each word in the list 270 of common words appearing in each preprocessed document 240 and creating a vector 320. For example, the word “trench” appears two times in preprocessed “Document_C” and the lemmatized word “fli” appears once each in “Document_A” and “Document_B.” Based on the counts of word instances in each preprocessed document 240, a similarity of the documents may be calculated. For example, an N×N matrix of similarity values 340 may be calculated using a cosine similarity, as shown in FIG. 3B, in which a similarity value 350 between “Document_C” and “Document_D” may be calculated as 0.24. Although an exemplary similarity computation is depicted in FIGS. 3A and 3B based on a cosine similarity, any other computed similarity metric, such as Euclidean distance, may be substituted. The calculated similarity metrics may be used to determine clusters of documents 210 within corpus 110.

FIGS. 4A-4B depict determining clusters within a corpus of textual data in a method for identifying latent themes in textual data, according to one or more embodiments. A process of determining clusters of documents 210 within corpus 110 may begin by searching matrix of similarity values 340 for a maximum similarity between pairs of documents. In the example shown in FIG. 3B, the maximum similarity metric is 0.40 between “Document_A” and “Document_B.” The process may then average, sum, or otherwise combine, the vectors of the documents into a new cluster, remove the individual documents from the original set of vectors, and add that of the cluster. The process may then calculate a similarity of the new cluster and each document among the preprocessed documents, such as by creating a new adjacency matrix using the set of vectors, and repeat this process until either there is only one cluster or the maximum calculated similarity metric is 0. The result of this process may be one or more document clusters 410, with each cluster including a list 420 of documents in the cluster. For example, two clusters 410, “Cluster0” including “Document_A” and “Document_B” and “Cluster1” including “Document_C” and “Document_D,” may be determined among documents 210 within corpus 110. Following this analysis, there may be a single cluster or a very small number of clusters, such as the two clusters in this example. When aggregating documents to associated clusters in this bottom-up approach, merely stopping when a desired number of clusters is reached may be sufficient to allow specification of a desired number of clusters. In the exemplary documents 210, however, “Cluster0” and “Cluster1” do not overlap, so 2 is both the minimum and the desired number of clusters. Once clusters among documents 210 within corpus 110 have been determined, a new data structure associating the preprocessed words 250 in each preprocessed document 240 may be created to be used in identifying latent themes in the textual data. For example, data structure 440 may be created for each cluster including a vector 450 for each document in the cluster. Vector 450 may include preprocessed words 250 in each preprocessed document 240 associated with the cluster.

FIGS. 5A-5D depict extracting topics in a corpus of textual data in a method for identifying latent themes in textual data, according to one or more embodiments. As shown in FIG. 5A, an analysis may be performed to identify topics within each cluster. For example, for identified “Cluster0” 440, a vector of topic words 510 for an associated cluster topic 505 may be determined. Vector of topic words 510 may include words 515 from the preprocessed words 250 in one or more preprocessed document 240 associated with the cluster. The analysis performed to identify topics within each cluster may include, for example, Latent Dirichlet Allocation (LDA) within each cluster in which parameters may vary based on the input dataset size and variability. However, other analyses that generate a list of topic words may also be used. Parameters to the analysis, such as LDA, may specify a maximum number of topic words to identify within each cluster. After extracting a list of topic words for each cluster, the topic word lists may be combined into a single topic word list 525, as shown in FIG. 5B. As shown in FIG. 5B, a vector of topic words 530 may include topic words 535. If any topic words 535 are contained in topic word lists for more than one cluster, then the duplicate topic words may be removed from vector of topic words 530. As shown in FIG. 5C, determining a similarity between documents 210 in corpus 110 and clusters 505 may include counting the instances of each word in the vector of topic words 530 appearing in each vector of topic words 510 for each cluster 505 and in each preprocessed document 240 and creating a vector 550. Based on the counts of word instances in each preprocessed document 240 and each cluster 505, a similarity of the documents and clusters may be calculated. For example, an N×N matrix 560 of similarity values may be calculated using a cosine similarity, as shown in FIG. 5D. For example, a similarity value 570 between “Document_C” and “Cluster1” may be calculated as 1. Although an exemplary similarity computation is depicted in FIGS. 5C and 5D based on a cosine similarity, any other computed similarity metric, such as Euclidean distance, may be substituted. The calculated similarity metrics may be used to determine clusters of documents 210 within corpus 110 and clusters 505. Following the analysis, one or more documents may be determined to not be similar to any other documents. That is, the document may be a cluster of one document and, accordingly, may be considered an outlier within corpus 110. The topic words 515 associated with each cluster 505 may then be associated with each document in the cluster in order to give the document a human-readable topic.

FIG. 6 depicts a flowchart of a method of identifying latent themes in textual data, according to one or more embodiments. As shown in FIG. 6, at operation 610, the method may receive a corpus of documents, such as corpus of documents 110 depicted in FIG. 1. At operation 620, the method may pre-process document text contained in the corpus of documents. For example, as shown in FIGS. 2A-2C, the preprocessing may include, for example, lemmatizing and tokenizing the text, removing stop words from the text, and/or generating a list, or vector, of common words within the text. At operation 630, the method may calculate a similarity of the documents. For example, as shown in FIGS. 3A-3B, the similarity analysis may include, for example, measuring the similarity of documents within the corpus. At operation 640, the method may determine clusters among documents. For example, as shown in FIGS. 4A-4B, the clustering analysis may include aggregating documents within the corpus into clusters based on the similarity analysis. At operation 650, the method may extract topics in document clusters. For example, as shown in FIGS. 5A-5D, the topic extraction may include, for example, extracting topics within the clusters of documents and associating documents within the clusters. At operation 660, the method may report document topics. For example, topic words may be stored in a searchable database associated with the documents or reports of identified topics and clusters of documents mat be generated.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, e.g., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The pre-processor 120, similarity analyzer 130, clustering analyzer 140, and topic extractor 150 may comprise software modules executed on one or more computer systems. Techniques discussed herein may be executed on one or more webpages. Such web pages may execute HTML, or other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Particular embodiments of the invention have been described. Other embodiments are within the scope of the following claims. For example, the steps recited in the claims can be performed in a different order and still achieve desirable results.

What is claimed is:

1. A computer-implemented method for identifying latent themes in textual data, the method comprising:
receiving a plurality of documents;
preprocessing document text for each document among the plurality of documents;
calculating a similarity of each pair of documents among the plurality of preprocessed documents;
determining one or more document clusters among the plurality of preprocessed documents based on the calculated similarity of each pair of documents among the plurality of preprocessed documents; and
extracting one or more topics in each document cluster among the determined one or more document clusters.

2. The computer-implemented method of claim 1, further comprising:
reporting the extracted one or more topics.

3. The computer-implemented method of claim 1, wherein preprocessing the document text for each document comprises:
performing one or more of: lemmatizing the document text for each document, stemming the document text for each document, tokenizing the document text for each document, removing stop words from the document text for each document; and
and constructing a list of words from the preprocessed document text for each document.

4. The computer-implemented method of claim 1, wherein calculating a similarity of each pair of preprocessed documents comprises:
counting instances of each word of the list of words appearing in the preprocessed document text for each document; and
calculating the similarity of each pair of documents based on the counted instances.

5. The computer-implemented method of claim 4, wherein the similarity of each pair of documents is calculated as a cosine similarity.

6. The computer-implemented method of claim 1, wherein determining one or more document clusters comprises iteratively performing until a desired number of document clusters is determined:
searching the calculated similarities of each pair of documents for a maximum similarity between pairs of documents;
averaging the similarities of the pair of documents having the maximum similarity into a new document cluster;
remove the individual documents of the pair of documents having the maximum similarity from the plurality of documents;
adding the new document cluster to the plurality of documents; and
calculating a similarity of the new cluster and each document among the plurality of preprocessed documents.

7. The computer-implemented method of claim 1, wherein extracting one or more topics in each document cluster comprises performing Latent Dirichlet Allocation (LDA) within each cluster.

8. The computer-implemented method of claim 7, wherein extracting one or more topics in each document cluster further comprises:
counting instances of each topic word identified by the LDA appearing in the preprocessed document text for each document and each cluster; and
calculating the similarity of each document and each cluster based on the counted instances of each topic word.

9. The computer-implemented method of claim 1, wherein a number of extracted topics in each document cluster is a user-specified maximum number of topics.

10. The computer-implemented method of claim 1, wherein a number of determined clusters is a user-specified maximum number of clusters.

11. The computer-implemented method of claim 1, further comprising:
identifying one or more outlier documents among the plurality of documents and one or more topics in the one or more outlier documents.

12. A system for identifying latent themes in textual data, the system comprising:
at least one data storage device storing instructions for identifying latent themes in textual data in an electronic storage medium; and
at least one processor configured to execute the instructions to perform operations including:
receiving a plurality of documents;
preprocessing document text for each document among the plurality of documents;
calculating a similarity of each pair of documents among the plurality of preprocessed documents;
determining one or more document clusters among the plurality of preprocessed documents based on the calculated similarity of each pair of documents among the plurality of preprocessed documents; and
extracting one or more topics in each document cluster among the determined one or more document clusters.

13. The system of claim 12, wherein preprocessing the document text for each document comprises:
performing one or more of: lemmatizing the document text for each document, stemming the document text for each document, tokenizing the document text for each document, removing stop words from the document text for each document; and
and constructing a list of words from the preprocessed document text for each document.

14. The system of claim 12, wherein calculating a similarity of each pair of documents comprises:
counting instances of each word of the list of words appearing in the preprocessed document text for each document; and
calculating the similarity of each pair of documents based on the counted instances.

15. The system of claim 12, wherein determining one or more document clusters comprises iteratively performing until a desired number of document clusters is determined:
searching the calculated similarities of each pair of documents for a maximum similarity between pairs of documents;
averaging the similarities of the pair of documents having the maximum similarity into a new document cluster;
remove the individual documents of the pair of documents having the maximum similarity from the plurality of documents;
adding the new document cluster to the plurality of documents; and
calculating a similarity of the new cluster and each document among the plurality of preprocessed documents.

16. The system of claim 12, wherein extracting one or more topics in each document cluster comprises:
counting instances of each topic word appearing in the preprocessed document text for each document and each cluster; and
calculating the similarity of each document and each cluster based on the counted instances of each topic word.

17. A non-transitory machine-readable medium storing instructions that, when executed by a computing system, causes the computing system to perform a operations for identifying latent themes in textual data, the operations comprising:
receiving a plurality of documents;
preprocessing document text for each document among the plurality of documents;
calculating a similarity of each pair of documents among the plurality of preprocessed documents;
determining one or more document clusters among the plurality of preprocessed documents based on the calculated similarity of each pair of documents among the plurality of preprocessed documents; and
extracting one or more topics in each document cluster among the determined one or more document clusters.

18. The non-transitory machine-readable medium of claim 17, wherein preprocessing the document text for each document comprises:
performing one or more of: lemmatizing the document text for each document, stemming the document text for each document, tokenizing the document text for each document, removing stop words from the document text for each document; and
and constructing a list of words from the preprocessed document text for each document.

19. The non-transitory machine-readable medium of claim 17, wherein determining one or more document clusters comprises iteratively performing until a desired number of document clusters is determined:
searching the calculated similarities of each pair of documents for a maximum similarity between pairs of documents;
averaging the similarities of the pair of documents having the maximum similarity into a new document cluster;
remove the individual documents of the pair of documents having the maximum similarity from the plurality of documents;
adding the new document cluster to the plurality of documents; and
calculating a similarity of the new cluster and each document among the plurality of preprocessed documents.

20. The non-transitory machine-readable medium of claim 17, wherein extracting one or more topics in each document cluster further comprises:
counting instances of each topic word appearing in the preprocessed document text for each document and each cluster; and
calculating the similarity of each document and each cluster based on the counted instances of each topic word.
